(19) United States
(12) Patent Application Publication
(10) Pub. No.: US 2013/0073261 A1
(43) Pub. Date: Mar. 21, 2013

(54) SENSOR SIGNAL PROCESSING APPARATUS AND SENSOR SIGNAL DISTRIBUTED PROCESSING SYSTEM INCLUDING THE SAME

(71) Applicants: Nac Woo KIM, Gwangju (KR); Hong Yeon Yu, Gwangju (KR); Seung Chul Son, Gwangju (KR); Byung Tak Lee, Gyeonggi-do (KR); Young Sun Kim, Daejeon (KR)

(72) Inventors: Nac Woo KIM, Gwangju (KR); Hong Yeon Yu, Gwangju (KR); Seung Chul Son, Gwangju (KR); Byung Tak Lee, Gyeonggi-do (KR); Young Sun Kim, Daejeon (KR)

(73) Assignee: Electronics & Telecommunications Research Institute, Daejeon (KR)

(21) Appl. No.: 13/615,322

(22) Filed: Sep. 13, 2012

(30) Foreign Application Priority Data
Sep. 21, 2011 (KR) 10-2011-0094952

(51) Int. Cl. G06F 15/00

(52) U.S. Cl. 702/189

(57) ABSTRACT

There are provided a sensor data processing apparatus, and a sensor data distributed processing system including the same. The sensor data distributed processing system includes: a plurality of sensors; one or more sensor data processing apparatuses each configured to compress a sensor signal received from at least one of a plurality of sensors, to create a compressed sensor signal, to adjust the sensor signal based on a reliability of the sensor signal, to analyze the adjusted sensor signal to provide analysis data, to synchronize the compressed sensor signal with the analysis data, to transmit the synchronized sensor data, and to provide management data to a corresponding sensor; and a sensor data management apparatus configured to monitor synchronized sensor data received from each sensor data processing apparatus, and to provide management data to the sensor data processing apparatus.

### CLAIM FOR PRIORITY

This application claims priority to Korean Patent Application No. 10-2011-0094952 filed on Sep. 21, 2011 in the Korean Intellectual Property Office (KIPO), the entire contents of which are hereby incorporated by reference.

### BACKGROUND

1. Technical Field

An example embodiment of the present invention relates in general to a sensor network system, and more specifically, to a sensor signal processing apparatus for distributively processing sensor signals received from a plurality of local sensors, and a sensor signal distributed processing system including the sensor data processing apparatus.

2. Related Art

With development of a ubiquitous sensor network (USN) and radio frequency identification (RFID)-related technology, technology for processing sensor-related events and data is attracting attention.

Specifically, studies into technology for acquiring sensor data in a ubiquitous environment and storing, searching for, and monitoring sensitive data to thereby provide sensor-based services are being conducted. The technology is classified into technology for processing a large amount of log data generated from a plurality of sensor nodes, technology for processing sensor data streams, such as interworking between sensors, processing of sensor-related events, data search, etc., and technology for providing various sensor-related applications. In particular, context-aware processing technology related to sensor events and data is applied to various systems.

Meanwhile, a conventional sensor data processing system has a client-server based, centralized management structure in which a central monitoring apparatus receives sensor data from a plurality of sensors and manages the sensor data.

However, since the central monitoring apparatus has to process all sensor data, the information processing capability of the conventional sensor data processing system deteriorates as sensor information increases, which leads to low reliability of the sensor data and low efficiency in use and management of resources.

Furthermore, since the sensors transmit sensor signals diagnosed to correspond to abnormal data to the central monitoring apparatus without considering synchronization, the central monitoring apparatus has difficulties in accurately determining when an error starts and terminates upon detecting abnormality based on the received sensor signals.

U.S. Pat. No. 7,065,465, entitled “Method and System for Multi-Sensor Data Fusion,” discloses technology for integrating data received from a plurality of sensors, in which data is received from each sensor in the system, a sensor reliability function is determined for each sensor based on the SNR of the received data, each sensor reliability function is individually weighted based on the SNR for each sensor and a comparison of predetermined sensor operation characteristics for each sensor, and then additive calculations are performed to provide a confidence level of the multi-sensor system.

However, U.S. Pat. No. 7,065,465 discloses only the configuration for evaluating the reliability of each sensor and providing the confidence level of the entire sensor system, without disclosing a technique for overcoming the drawback of the conventional client-server based, centralized management structure.

### SUMMARY

Accordingly, example embodiments of the present invention are provided to substantially obviate one or more problems due to limitations and disadvantages of the related art.

An example embodiment of the present invention provides a sensor data processing apparatus capable of maximizing the efficiency in signal processing and system management by distributively processing sensor signals.

Another example embodiment of the present invention provides a sensor data distributed processing system including the sensor data processing apparatus capable of distributively processing sensor signals.

In an example embodiment, there is provided a sensor data processing apparatus including: a sensor data compressor configured to compress a sensor signal received from at least one of a plurality of sensors, and to provide a compressed sensor signal; a sensor data analyzer configured to determine a reliability of the sensor signal, to adjust the sensor signal based on the determined reliability of the sensor signal, and to analyze the adjusted sensor signal, thereby providing analysis data; a transceiver configured to synchronize the compressed sensor signal with the analysis data, to transmit the synchronized sensor data to a sensor data management apparatus, and to receive management data from the sensor data management apparatus; a sensor operation setting unit configured to receive the management data from the sensor data management apparatus through the transceiver, and to provide the management data to a corresponding sensor; and a sensor data storage configured to store information about a reliability of each sensor for determining the reliability of the sensor.

The sensor data processing apparatus may further include a sensor data acquiring unit configured to recognize the sensor signal received from the plurality of sensors, to decide a method for processing the recognized sensor signal, and to provide the sensor signal to the sensor data compressor or the sensor data analyzer according to the decided method.

The transceiver may provide information about a network state to the sensor data compressor, and the sensor data compressor may adjust a compression method of the sensor signal or a compression rate of the sensor signal based on the information about the network state.

The sensor data analyzer may acquire a reliability weight level of a sensor that has transmitted the sensor signal, from the sensor data storage, and adjust the sensor signal based on the reliability weight level of the sensor, the reliability weight level of the sensor varying according to whether or not the sensor has an error.

The sensor data analyzer may transform the adjusted sensor signal to extract characteristic information from the adjusted sensor signal, classify the characteristic information, and analyze the result of the classification to determine whether the sensor signal indicates an abnormal situation, thereby creating the analysis data.

The transceiver may insert the analysis data into a user-defined field of a codec for compressing the sensor signal, or into a user-defined field of a multiplexing frame, thereby synchronizing the compressed sensor signal with the analysis data.

The sensor operation setting unit may provide operation rule data or software update data of a sensor, received from the sensor data management apparatus, to the corresponding sensor.

In another example embodiment, there is provided a sensor data distributed processing system including: a plurality of sensors; one or more sensor data processing apparatuses each configured to compress a sensor signal received from at least one of a plurality of sensors, to create a compressed sensor signal, to adjust the sensor signal based on a reliability of the sensor signal, to analyze the adjusted sensor signal to provide analysis data, to synchronize the compressed sensor signal with the analysis data, to transmit the synchronized sensor data, and to provide received management data to a corresponding sensor; and a sensor data management apparatus configured to monitor synchronized sensor data received from each sensor data processing apparatus, and to provide management data to the sensor data processing apparatus.

The sensor data processing apparatus may compress the sensor signal using a compression method or a compression rate adjusted according to information about a network state.

The sensor data processing apparatus may acquire a reliability weight level of a sensor that has transmitted the sensor signal, from a database, and adjust the sensor signal based on the reliability weight level of the sensor, the reliability weight level of the sensor varying according to whether or not the sensor has an error.

The sensor data processing apparatus may transform the adjusted sensor signal to extract characteristic information from the adjusted sensor signal, classifies the characteristic information, and analyze the result of the classification to determine whether the sensor signal indicates an abnormal situation, thereby creating the analysis data.

The sensor data management apparatus may provide operation rule data or software update data for the corresponding sensor to the sensor data processing apparatus that has transmitted the synchronized sensor data, and the sensor data processing apparatus may provide the operation rule data or the software update data to the corresponding sensor.

When the sensor data management apparatus has generated an error or according to setting from an operator, a predetermined sensor data processing apparatus of the one or more sensor data processing apparatuses may monitor synchronized sensor data received from another sensor data processing apparatus of the one or more sensor data processing apparatuses, and provide the management data to the other sensor data processing apparatus.

According to the sensor data processing apparatus and the sensor data distributed processing system including the same, by distributively configuring one or more sensor data processing apparatuses for processing sensor signals received from a plurality of sensors in different regions and distributively processing the sensor signals in units of local wired/wireless networks, it is possible to shorten a processing response time with respect to sensor data, and provide flexible extensibility of a sensor network system.

Also, by transmitting synchronized data of a compressed sensor signal with analysis data upon data transmission for monitoring between the sensor data processing apparatus and the sensor data management apparatus, it is possible to accurately determine when the sensor data has been analyzed upon management of the sensor data so that a sensor network system manager can correctly determine and predict a problem upon monitoring of the system state.

Furthermore, by determining the reliabilities of sensor signals received from various sensors, analyzing the sensor signals in consideration of the reliabilities of the sensor signals, and updating the reliabilities of the sensor signals based on the cause of errors related to the analysis data, it is possible to prevent a system manager from instructing an alarm or to processing based on sensor data inferred from sensor signals transmitted from a broken sensor.

In addition, it is possible to set sensor operation rules or perform remote software update in real time, according to a local network, through a bidirectional communication and control structure between the plurality of sensors and the sensor data processing apparatus or the sensor data management apparatus, and accordingly a time taken for sensor operators to process setting modification for the sensors can be greatly reduced.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating an example of a sensor data distributed processing system;

FIG. 2 is a block diagram illustrating a sensor data processing apparatus of FIG. 1; and

FIG. 3 is a block diagram illustrating a sensor data analyzer of FIG. 2.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the example embodiments of the present invention will be described in detail with reference to the appended drawings. In the following description, for easy understanding, like numbers refer to like elements throughout the description of the figures, and the same elements will not be described further.

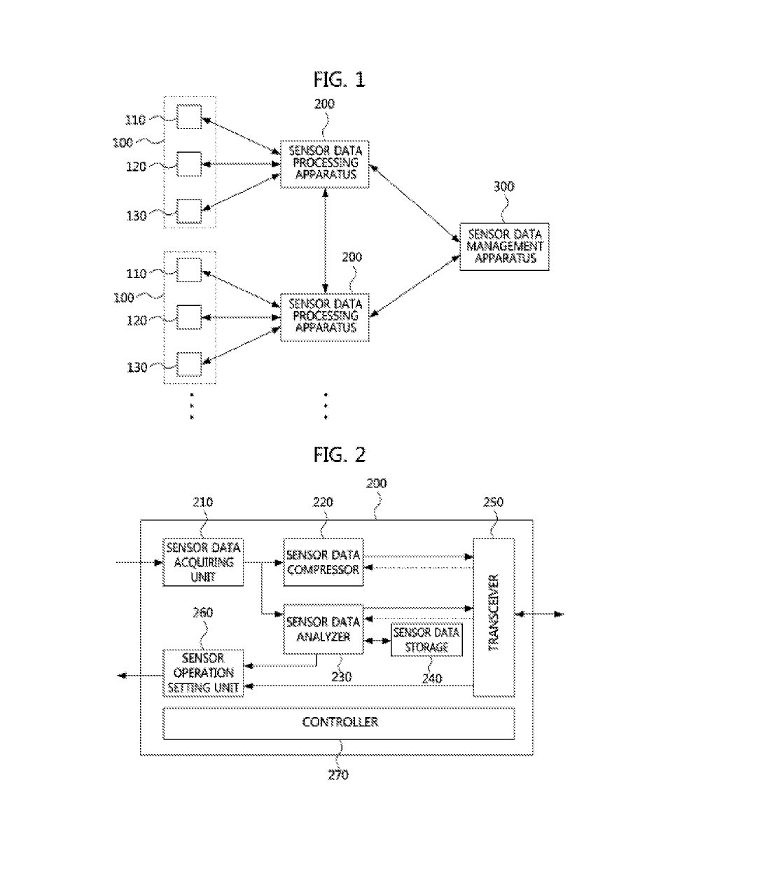

FIG. 1 is a block diagram illustrating an example of a sensor data distributed processing system.

Referring to FIG. 1, the sensor data distributed processing system may include one or more sensor groups 100 (100 for each), one or more sensor data processing apparatuses 200 (200 for each), and a sensor data management apparatus 300. The sensor data management apparatus 300 may be replaced by an arbitrary one of the sensor data processing apparatuses 200. In this case, the corresponding sensor data processing apparatus 200 is configured to perform the functions of the sensor data management apparatus 300, as well as functions of the sensor data processing apparatus 200. For example, the sensor data processing apparatus 200 functioning as the sensor data management apparatus 300 may monitor the other sensor data processing apparatuses 200 and set operation rules for the sensor data processing apparatuses 200. By using an arbitrary one of the sensor data processing apparatuses 200 as the sensor data management apparatus 300, when the sensor data management apparatus 300 has a problem, the sensor data management apparatus 300 can be replaced by another arbitrary one of the sensor data processing apparatuses 200 to thereby keep managing the sensor data distributed processing system.

The sensor groups 100 may be distributively installed in different regions, and each sensor group 100 may include a variety of kinds of sensors.

For example, each sensor group 100 may include a general sensor 110 including a temperature sensor, a humidity sensor, an air quality sensor, etc., a sound sensor 120 including a microphone, a sound level meter, etc., and an image sensor 130 including a camera, CCTV, etc. The general sensor 110, the sound sensor 120, and the image sensor 130 may be grouped together and installed in a specific region, or may be independently installed in different locations or regions.

Each sensor data processing apparatus 200 receives various sensor signals from the sensor group 100, adjusts the sensor signals based on the reliabilities of the respective sensors that have transmitted the sensor signals, acquires analysis data resulting from predicting and analyzing current states and future states based on the adjusted sensor signals, synchronizes the analysis data with compressed results of the sensor signals, and then transmits the synchronized results to the sensor data management apparatus 300.

Also, the sensor data processing apparatus 200 provides each sensor with an execution command and a command related to setting modification, based on the result of determination on the reliability of the sensor, thereby correcting any error of the sensor or controlling the operation of the sensor.

Here, the sensor group 100 may be connected to the sensor data processing apparatus 200 through a wired or wireless local network according to a region, and the sensor data processing apparatus 200 may receive sensor signals from the sensor group 100 on the same local network and process the sensor signals.

The sensor data management apparatus 300 monitors the state of the system based on data received from the sensor data processing apparatuses 200 to thereby manage the system. The sensor data management apparatus 300 may perform remote software update, alarm rule update, etc. The function of the sensor data management apparatus 300 may be performed by an arbitrary one of the sensor data processing apparatuses 200.

According to the sensor data distributed processing system shown in FIG. 1, the sensor data processing apparatuses 200 are distributively configured according to the number of the sensor groups 100 and/or a region or location at which each sensor group 100 is installed. Each sensor data processing apparatus 200 performs processing, such as processing of sensing signal events, signal analysis, data modeling, compression, interworking with DB, etc., which has been performed by a central monitoring apparatus in conventional technologies. The sensor data management apparatus 300 receives sensor data processed by the sensor data processing apparatuses 200 and performs processing, such as monitoring, remote software update, alarm rule update, etc., so that processing loads are distributively applied to the sensor data processing apparatuses 200 and the sensor data management apparatus 300, resulting in maximization of the processing efficiency of the system.

FIG. 2 is a block diagram illustrating the sensor data processing apparatus 200 of FIG. 1.

Referring to FIG. 2, the sensor data processing apparatus 200 includes a sensor data acquiring unit 210, a sensor data compressor 220, a sensor data analyzer 230, a sensor data storage 240, a transceiver 250, a sensor operation setting unit 260, and a controller 270.

Referring to FIGS. 1 and 2, the sensor data acquiring unit 210 recognizes each of sensor signals received from the sensor group 100, selects a method for processing the sensor signal based on the result of the recognition, and then provides the sensor signal to the sensor data compressor 220 or the sensor data analyzer 230 according to the selected method.

That is, if it is determined that the sensor signal needs to be compressed, the sensor data acquiring unit 210 provides the sensor signal to the sensor data compressor 220, and if it is determined that the sensor signal needs to be analyzed, provides the sensor signal to the sensor data analyzer 230. For example, if it receives a sound signal from the sound sensor 120 or an image signal from the image sensor 130, the sensor data acquiring unit 210 may provide the sound signal or the image signal to the sensor data compressor 220, and if it receives a sensor signal, such as temperature, humidity, etc., which needs to be analyzed, from the general sensor 110, the sensor data acquiring unit 210 may provide the sensor signal to the sensor data analyzer 230.

The sensor data compressor 220 performs format conversion and/or compression on the received sensor signal, and may include an analog-to-digital converter and various kinds of codecs for compressing sound or image signals. If the sensor data compressor 220 receives digital sensor signals from the sensor data acquiring unit 210, the sensor data compressor 220 may perform only compression without performing analog-to-digital conversion.

Also, the sensor data compressor 220 selects a compression rate or a compression method adaptively based on network state data received from the transceiver 250, and performs compression according to the compression rate or the compression method.

The sensor data analyzer 230 adjusts the sensor signal received from the sensor data acquiring unit 210, in consideration of the reliability of the sensor that has transmitted the sensor signal, and extracts characteristic information from the adjusted sensor signal.

Also, the sensor data analyzer 230 performs clustering modeling and segmentation/classification on the corresponding sensor data, based on the extracted characteristic information, and then performs analysis, such as state analysis, flow prediction, abnormality diagnosis, etc., on the segmented/classified sensor data. The sensor data analyzer 230 checks the result of abnormality diagnosis on the sensor signal, based on the analysis data of the sensor signal, determines a reliability of the corresponding sensor based on the result of the determination, and provides information about the determined reliability of the sensor to the sensor through the sensor operation setting unit 260.

Also, when the sensor data management apparatus 300 cannot operate normally due to occurrence of errors, etc., or according to setting from an operator, the sensor data analyzer 230 may perform the function of the sensor data management apparatus 300. For example, the sensor data analyzer 230 may receive analysis data about sensor signals from another sensor data processing apparatus, monitor the analysis data about sensor signals, set operation rules, etc. of sensors connected to the other sensor data processing apparatus, and provide information about the operation rules, etc. to the sensors.

The sensor data storage 240 stores a rule for evaluating the reliability of sensor data, data for classification, analysis data of sensor data, a rule for sensor analysis, etc.

The transceiver 250 manages a network connection between the sensor data processing apparatus 200 and the sensor data management apparatus 300, synchronizes the compressed data of sensor data received from the sensor data compressor 220 with the analysis data of sensor data received from the sensor data analyzer 230, and transmits the synchronized sensor data to the sensor data management apparatus 300. For synchronization of the analysis data of sensor data with the compressed data of sensor data, the transceiver 250 may insert the analysis data into a user-defined field in an image or sound compression codec, or if a multiplexing frame such as MPEG2-TS is configured, the transceiver 250 may define a user-defined field and insert the analysis data into the user-defined field.

Also, the transceiver 250 receives signals from the sensor data management apparatus 300, and transfers the signals to the sensor data compressor 220, the sensor data analyzer 230, or the sensor operation setting unit 260.

Also, the transceiver 250 monitors a network state, and provides information about the network state to the sensor data compressor 220 so that the sensor data compressor 220 can adjust a compression method or a compression rate adaptively according to the network state.

The sensor operation setting unit 260 receives operation rule data or software (or firmware) update data for each sensor in the sensor group 100, according to the results of abnormality diagnosis on sensor data and/or setting modification of the sensor, etc., from the sensor data management apparatus 300, through the transceiver 250, and provides the received data to the corresponding sensor. Or, the sensor operation setting unit 260 sets a reliability value of each sensor, received from the sensor data analyzer 230, to the corresponding sensor.

The controller 270 controls the processing procedures of the components, a database, processing times, etc.

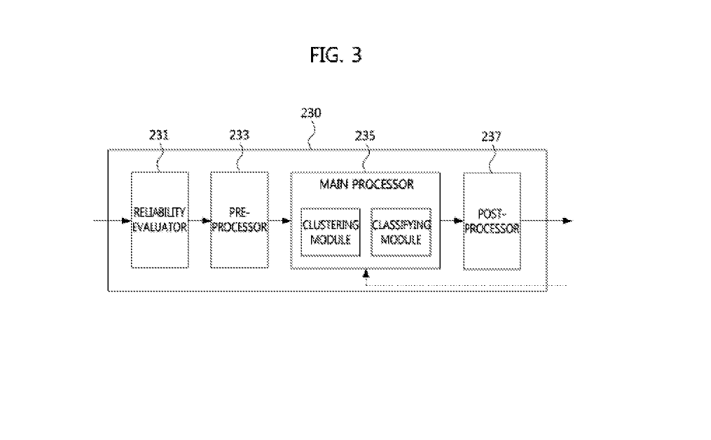

FIG. 3 is a block diagram illustrating the sensor data analyzer 230 of FIG. 2.

Referring to FIG. 3, the sensor data analyzer 230 includes a reliability evaluator 231, a pre-processor 233, a main processor 235, and a post-processor 237.

The reliability evaluator 231 determines the reliability of a sensor signal received from the sensor signal acquiring unit 210 (see FIG. 2), and adjusts the sensor signal based on the determined reliability of the sensor signal. At this time, the reliability evaluator 231 accesses a database stored in the sensor data storage 240 (see FIG. 2) to determine whether a sensor that has transmitted the sensor signal is reliable, and filters the sensor signal according to the result of the determination.

For example, if a plurality of sensor signals are provided (for example, if a plurality of sensing signals are provided from a plurality of temperature sensors installed in the same space), the reliability evaluator 231 allocates different weights to the respective sensor signals according to the reliabilities of the respective sensors that have transmitted the sensor signals, to adjust the sensor signals, thereby improving the entire reliability of the sensor signals.

A method for setting a reliability value for each sensor will be described in more detail below. When a system is configured, sensors are set to have predetermined reliability values. The predetermined reliability values of the sensors may be set by an operator. Also, the sensors may be allocated differentiated reliability values according to the prices of the sensors, the specifications of the sensors, the brand values of manufacturing companies, etc.

Thereafter, if specific sensor data provided to the sensor data management apparatus 300 (see FIG. 1) is analyzed to correspond to abnormal data and it is determined that the corresponding sensor itself has an error, the reliability weight level of the sensor is adjusted to a reliability weight level that is one level lower than the current reliability weight level among a plurality of predetermined reliability weight levels. However, if it is determined that the corresponding sensor has no error, the reliability weight level of the sensor is adjusted to a reliability weight level that is one level higher than the current reliability weight level.

A reliability weight level of each sensor is directly input as sensor setting information through the sensor operation setting unit 260, or has been stored in the sensor data storage 240.

The reliability evaluator 231 filters received sensor signals in consideration of the reliability weight levels of the sensor signals to thus adjust the sensor signals. The reliability evaluator 231 may adjust the received sensor signals using equation 1, below.

AdjustedSensorSignal=a1SensorSignal1+a2SensorSignal2+a3SensorSignal3. (1)

In equation 1, a represents the reliability weight level of the corresponding sensor signal. As seen in equation 1, the reliability evaluator 231 may multiply the received sensor signals by the corresponding reliability weight levels and sum the resultant sensor signals to adjust the received sensor signals, thereby evaluating the reliability of the received sensor signals.

Referring again to FIG. 3, the pre-processor 233 receives each sensor signal in which the reliability of the corresponding sensor has been reflected, from the reliability evaluator 231, and extracts characteristic information from the sensor signal. For example, the pre-processor 233 performs a spatial frequency transform on a received sensor signal to extract vectorized characteristic information from the sensor signal.

The main-processor 235 may include a clustering module and a classifying module, and performs clustering modeling, segmentation/classification, etc. on the received sensor signal, based on the characteristic information of the sensor signal received from the pre-processor 233. The clustering module clusters the characteristic information of the sensor signal into n classes in real time or in nonreal time, wherein n is a natural number equal to or greater than 1. The classifying module segments each piece of the clustered data into m areas, and maps the m areas to a k-dimensional space to thereby classify the corresponding sensor data, wherein m and k are natural numbers equal to or greater than 1.

The post-processor 237 analyzes the received sensor data to determine whether the sensor data corresponds to data (that is, abnormal data) indicating an abnormality situation (or an abnormality state) or data (normal data) indicating a normal situation (or a normal state), based on the sensor data classified by the main processor 235, predicts a flow of states in consideration of the currently analyzed data and analysis data previously analyzed and stored, and diagnoses abnormality. Also, the post-processor 237 checks the result of abnormality diagnosis on the sensor signal, based on the analysis data of the sensor signal, and determines the reliability of the corresponding sensor that has transmitted the sensor signal, based on the result of the abnormality diagnosis.

While the example embodiments of the present invention and their advantages have been described in detail, it should be understood that various changes, substitutions and alterations may be made herein without departing from the scope of the invention.

What is claimed is:

1. A sensor data processing apparatus comprising:
a sensor data compressor configured to compress a sensor signal received from at least one of a plurality of sensors, and to provide a compressed sensor signal;
a sensor data analyzer configured to determine a reliability of the sensor signal, to adjust the sensor signal based on the determined reliability of the sensor signal, and to analyze the adjusted sensor signal, thereby providing analysis data;
a transceiver configured to synchronize the compressed sensor signal with the analysis data, to transmit the synchronized sensor data to a sensor data management apparatus, and to receive management data from the sensor data management apparatus;
a sensor operation setting unit configured to receive the management data from the sensor data management apparatus through the transceiver, and to provide the management data to a corresponding sensor; and
a sensor data storage configured to store information about a reliability of each sensor for determining the reliability of the sensor.

2. The sensor data processing apparatus of claim 1, further comprising a sensor data acquiring unit configured to recognize the sensor signal received from the plurality of sensors, to decide a method for processing the recognized sensor signal, and to provide the sensor signal to the sensor data compressor or the sensor data analyzer according to the decided method.

3. The sensor data processing apparatus of claim 1, wherein the transceiver provides information about a network state to the sensor data compressor, and the sensor data compressor adjusts a compression method of the sensor signal or a compression rate of the sensor signal based on the information about the network state.

4. The sensor data processing apparatus of claim 1, wherein the sensor data analyzer acquires a reliability weight level of a sensor that has transmitted the sensor signal, from the sensor data storage, and adjusts the sensor signal based on the reliability weight level of the sensor, the reliability weight level of the sensor varying according to whether or not the sensor has an error.

5. The sensor data processing apparatus of claim 1, wherein the sensor data analyzer transforms the adjusted sensor signal to extract characteristic information from the adjusted sensor signal, classifies the characteristic information, and analyzes the result of the classification to determine whether the sensor signal indicates an abnormal situation, thereby creating the analysis data.

6. The sensor data processing apparatus of claim 1, wherein the transceiver inserts the analysis data into a user-defined field of a codec for compressing the sensor signal, or into a user-defined field of a multiplexing frame, thereby synchronizing the compressed sensor signal with the analysis data.

7. The sensor data processing apparatus of claim 1, wherein the sensor operation setting unit provides operation rule data or software update data of a sensor, received from the sensor data management apparatus, to the corresponding sensor.

8. A sensor data distributed processing system comprising:
a plurality of sensors;
one or more sensor data processing apparatuses each configured to compress a sensor signal received from at least one of a plurality of sensors, to create a compressed sensor signal, to adjust the sensor signal based on a reliability of the sensor signal, to analyze the adjusted sensor signal to provide analysis data, to synchronize the compressed sensor signal with the analysis data, to transmit the synchronized sensor data, and to provide received management data to a corresponding sensor; and
a sensor data management apparatus configured to monitor synchronized sensor data received from each sensor data processing apparatus, and to provide management data to the sensor data processing apparatus.

9. The sensor data distributed processing system of claim 8, wherein the sensor data processing apparatus compresses the sensor signal using a compression method or a compression rate adjusted according to information about a network state.

10. The sensor data distributed processing system of claim 8, wherein the sensor data processing apparatus acquires a reliability weight level of a sensor that has transmitted the sensor signal, from a database, and adjusts the sensor signal based on the reliability weight level of the sensor, the reliability weight level of the sensor varying according to whether or not the sensor has an error.

11. The sensor data distributed processing system of claim 8, wherein the sensor data processing apparatus transforms the adjusted sensor signal to extract characteristic information from the adjusted sensor signal, classifies the characteristic information, and analyzes the result of the classification to determine whether the sensor signal indicates an abnormal situation, thereby creating the analysis data.

12. The sensor data distributed processing system of claim 8, wherein the sensor data management apparatus provides operation rule data or software update data for the corresponding sensor to the sensor data processing apparatus that has transmitted the synchronized sensor data, and the sensor data processing apparatus provides the operation rule data or the software update data to the corresponding sensor.

13. The sensor data distributed processing system of claim 8, wherein when the sensor data management apparatus has generated an error or according to setting from an operator, a predetermined sensor data processing apparatus of the one or more sensor data processing apparatuses monitors synchronized sensor data received from another sensor data processing apparatus of the one or more sensor data processing apparatuses, and provides the management data to the other sensor data processing apparatus.
